(19) United States
(12) Patent Application Publication
(10) Pub. No.: US 2013/0300851 A1
(43) Pub. Date: Nov. 14, 2013

(54) INSTRUMENT CLUSTER ARRANGEMENT

(71) Applicant: VOLVO CAR CORPORATION, Goeteborg (SE)

(72) Inventor: Henrik Olof Lind, Torslanda (SE)

(73) Assignee: VOLVO CAR CORPORATION, Goeteborg (SE)

(21) Appl. No.: 13/891,372

(22) Filed: May 10, 2013

(30) Foreign Application Priority Data
May 14, 2012 (EP) 12167828.8

(51) Int. Cl. H04N 7/18

(52) U.S. Cl. CPC H04N 7/183
USPC 348/77

(57) ABSTRACT

An instrument cluster arrangement adapted for mounting in a dashboard panel of a vehicle includes a display having a display surface providing a graphics area of the instrument cluster arrangement. The arrangement also includes a detector for monitoring a subject inside the vehicle, which is arranged to receive radiation providing information regarding the subject. The arrangement also includes a reflector arranged to redirect radiation from the subject toward the detector, where the detector and the reflector are both arranged in the instrument cluster arrangement, adjacent the display.

### CROSS-REFERENCE TO RELATED APPLICATIONS

This application claims priority to European Patent Application No. 12167828.8 filed May 14, 2012, the disclosure of which is incorporated in its entirety by reference herein.

### TECHNICAL FIELD

The present disclosure relates to an instrument cluster arrangement, being adapted for mounting in a dashboard panel of a vehicle, comprising a display having a display surface providing a graphics area of the instrument cluster arrangement.

### BACKGROUND

In the vehicle industry, there is a trend towards monitoring the behaviour of a subject in the vehicle during a drive, in particular of monitoring the driver. Information regarding the subject may be used for numerous purposes. For example, safety applications might use the information to determine whether the driver is drowsy or otherwise impaired, and may issue a warning if that is the case. Other applications may use information regarding the driver to determine whether the driver is focused on the driving task, or whether he/she is distracted by e.g. events occurring inside the vehicle. The behaviour of the driver may be used in combination with other systems for example for determining which information should be presented to the driver from various in-vehicle applications, and how said information shall be presented. Moreover, information regarding the facial features of the driver may be used to determine who is driving the vehicle, and serve as a basis for automatic setting of personalized features in the vehicle.

In summary, there is a need for monitoring a subject in a vehicle. In particular, there is for some applications a need to monitor the eye movements and/or head position of a driver in a vehicle.

To this end, it has been proposed to use different types of detectors, such as cameras, for retrieving information regarding a subject in a vehicle.

In the past, various locations in the vehicle have been proposed for the arrangement of detectors for monitoring a subject in a vehicle.

U.S. Pat. No. 6,926,429 for example, proposes that a detector is arranged somewhere behind the driver of a vehicle. Radiation (light) is directed from the driver to the detector via a radiation path involving reflection of said radiation in a dedicated area of the windshield, and in two separately arranged reflectors.

Also U.S. Pat. No. 7,091,867 suggests a location for the detector, where a dichroic mirror comprising the windshield of the vehicle is used to reflect the radiation between the driver and the detector.

Often, the detector may conveniently be positioned at a suitable location in the dashboard panel of a vehicle, for example somewhere in the instrument cluster including the major instruments such as speed indicator, oil pressure and the like. This location of the detector provides advantages in that the necessary power supply and control signals, as well as the data from the detector, may be transmitted via interfaces situated adjacent the interfaces of the instruments of the instrument cluster. Hence, there will be a dedicated interface area for connection to the instrument cluster, which comprises also the necessary connections to the detector. In other words—no new interface area must be created for handling the detector. Moreover, the mechanical arrangement of the detector in the vehicle may be conveniently made in connection with the arrangement of the other instruments in the dashboard panel. In other words, there is no need to carry out a separate mounting procedure for the detector, such as would be the case if arranging the detector at a more unusual location e.g. in the roof of the vehicle.

Hence, it is desired to provide the detector for monitoring a subject in the vehicle in the instrument cluster arrangement of a vehicle.

However, the development of instrument clusters brings along a desire to use displays, such as LCD displays, for presenting information to the driver, rather than the conventional analogue instruments. Moreover, it is naturally desired to use a relatively large surface of the dashboard for such a LCD display—generally most of the surface conventionally used for the instrument cluster, situated adjacent the steering wheel hub and behind the steering wheel of the vehicle.

Use of such LCD displays implies that the area of the dashboard in which detectors for monitoring the driver has previously been arranged is now covered by the LCD display and no longer available for arrangement of a detector.

Hence, there is a need for a solution enabling use of a detector for monitoring a subject in the vehicle, while having an instrument cluster arrangement comprising a display.

The solution may enable that the display may cover a major part of the surface of the dashboard available for the cluster arrangement.

The object of the disclosure is to provide a solution which enables the fulfillment of at least one the above-mentioned needs.

### SUMMARY

The above-mentioned object is achieved in first aspect of the disclosure by an instrument cluster arrangement, being adapted for mounting in a dashboard panel of a vehicle, comprising

a display having a display surface providing a graphics area of the instrument cluster arrangement,

a detector for monitoring a subject inside the vehicle, said detector being arranged to receive radiation providing information regarding the subject, and

a reflector arranged to redirect radiation from said subject towards said detector, wherein the detector and the reflector are both arranged in said instrument cluster arrangement, adjacent the display.

By providing both a detector and a reflector in the instrument cluster arrangement, the detector and reflector may be mounted to the dashboard panel of the vehicle together with the instrument cluster arrangement, whereby no additional mounting solutions need to be provided in order to arrange the detector for monitoring a subject inside the vehicle.

The reflector with the purpose of redirecting radiation from the subject to the detector, enables the detector to be positioned at a location and/or with a direction which does not allow direct access to radiation from the subject.

Advantageously, the detector may be arranged next to an outer border of the display surface.

Accordingly, the size of the display surface need not be limited in order for the detector to find a suitable location. Advantageously, the display surface encompasses at least 50%, more preferred at least 75%, most preferred at least 90% of an outer surface of the cluster arrangement. With the outer surface of the instrument cluster arrangement is meant the surface which will be visible when the instrument cluster arrangement is arranged in the dashboard of a vehicle.

The detector may advantageously be arranged at a location at which the detector, when the instrument cluster arrangement is mounted in the dashboard panel, is at least potentially blocked from access to direct radiation from the subject. With “potentially blocked”, is meant that the location, during use of the vehicle, may sometimes be blocked from access to direct radiation from the subject, and sometimes not. Typically, such a location could be a location which is sometimes blocked by the steering wheel of the vehicle, and then, when the steering wheel is turned, is not blocked by the steering wheel. Such a location is hence not a reliable location when continued access to radiation from the driver is required. The detector being “constantly blocked” from access to direct radiation means that it is located where there is never access to direct radiation from the driver. Typically, the detector could be constantly blocked by a portion of the steering wheel or by the steering wheel hub.

The detector will have an optical axis, and may be arranged with said optical axis forming an angle with said display surface being in the range −10 to 30 degrees, preferably −10 to 15 degrees, most preferred −10 to 10 degrees. Accordingly, the optical axis forming an angle with the display surface being 0 will correspond to the optical axis being parallel with the display surface. Negative angles are in this context to be interpreted as being formed when the optical axis is directed towards the display surface, and positive angles are formed when the optical axis is directed in a direction away from the display surface.

Hence, it is understood that the detector is not directed directly towards the subject to be monitored, but in a direction suitable for receiving radiation reflected via the reflector. When the angle to the display surface is relatively small, the reflector may conveniently be positioned relatively close to the detector.

With the term “optical axis” is meant a central direction of the detection. For example, a camera could receive impeding radiation from a number of directions, such that a cone of directions forms a field of view of the camera. With optical axis is meant the centre direction of such a cone, the direction towards which the objective of the camera is directed.

Said detector may be arranged with the optical axis being essentially parallel to said display surface.

The reflector may be arranged between the detector and the display surface. This allows for the reflector being arranged close to the detector. The shorter the distance between the reflector and the detector, the less extension is required by the reflector.

Moreover, as the display extends between an upper edge and a lower edge, as seen by a subject in the vehicle, said reflector and said detector are arranged adjacent to the lower edge of the display. This location is advantageous in terms of function and of visibility. It is generally required that the detector and the reflector shall be as discreet as possible, not catching the interest of the subject. Instead, the subject (driver) should be able to focus on the instrument information being presented on the display surface.

In other embodiments, the reflector may be arranged e.g. on a side of the display surface opposing the detector. In this case, however, the distance between the detector and the reflector is relatively large, and a larger reflector might be necessary. Hence, this embodiment will not be as discreet as the one mentioned above.

Advantageously, the reflector is arranged with a reflective surface forming an angle of at least 100 degrees, preferably between 115 and 155 degrees in relation to the display surface.

Naturally, the angle of the reflector in relation to the display surface should be adapted to the angle of the detector in relation to the display surface, such that the intended redirection of radiation between the subject and the detector is accomplished.

The reflector may advantageously be arranged so as to extend over a margin area of the display surface. With “margin area” of the display surface, is meant an area extending from one of the outer edges of the display surface, towards the centre of the display surface. Hence, the reflector may be arranged at an outer edge of the display surface, and extending obliquely from the outer edge over the display surface. Hence the reflector will be directed such that its reflective surface extends in a direction having a component along the display surface.

Hence, the margin area might be covered by the reflector extending over it.

The reflector may be transparent to light in the visible region. Accordingly, even if the reflector extends over a marginal area of the display surface, the entire display surface may be seen by the subject, although partly through the reflector.

Advantageously, the margin area may constitute less than 10%, preferably less than 5% of the total area of the display surface. It is generally desired that the margin area is relatively small, so that any negative influence on the visibility of the display surface, caused by the reflector, is kept at a minimum.

In view of the above, it will be understood that the configuration with the detector and the reflector being arranged on the same edge of the display surface, and with the reflector in between the detector and the display surface, will result in a relatively short distance between the detector and the reflector. This, in turn, means that the reflector may have relatively small dimensions, and the margin area over which the reflector extends is also relatively small. For example, the distance between the detector and the reflector may be in the range 0 to 5 mm.

Advantageously, the reflector may have an extension along a direction being parallel to the display surface being less than 50 mm, preferably less than 10 mm. With extension along a direction parallel to the display surface is meant the component in that direction. The reflector as a whole will extend in a direction forming an angle to said display surface, as mentioned above.

The reflector width must at least be such as required by the size of the optics (field of view, lens opening and reflective angle) and may as most extend to the size of the display width plus possibly side portions extending beyond the display width. Any such side portions should be relatively small, maximum 30 mm in total.

Advantageously, the reflector extends from a basal end being arranged adjacent to said display area, and a free end opposite said basal end, said free end having an end surface forming an angle of approximately 90 degrees in relation to the display surface.

Accordingly, the visibility of the end surface will be diminished, since reflections against the end surface which could possibly disturb the view of the display surface are avoided.

Advantageously, said reflector is a dichroic mirror. The reflector may hence be transparent to visible light, as mentioned above, but reflect radiation corresponding to the functionality of the detector.

Advantageously, the radiation detected could be light outside of the visible region of the spectrum, such as IR radiation.

Advantageously, the instrument cluster could also comprise at least one radiation transmitter being arranged adjacent said display, for transmitting radiation towards the subject. Several types of detectors require a suitable radiation illuminating the subject in order to enable information gathering. By arranging the source of said radiation, the radiation transmitter, in the instrument cluster, further advantages in mounting and construction is achieved, since the entire detection system may be provided in the instrument cluster arrangement.

The radiation transmitter may be arranged to transmit radiation directly towards the subject. With directly towards means that the radiation from the transmitter may immediately reach the subject, not requiring any redirection along the way.

In this case, the radiation transmitter may for example be arranged to transmit radiation in a direction forming an angle of about 45 to 135 degrees to the display surface, more preferred about 60 to 120 degrees, most preferred about 90 degrees to the display surface.

Alternatively, the radiation transmitter may be arranged to transmit radiation towards the reflector, and the reflector redirects the radiation towards the subject. In this case, the radiation transmitter may be arranged to transmit radiation in a direction close to parallel to the optical axis of the detector.

Advantageously, the at least one radiation transmitter is arranged adjacent the detector. This is particularly advantageous when the mirror is to be used for redirecting the radiation from the transmitter.

Advantageously, two radiation transmitters may be arranged in the instrument cluster. The use of two radiation transmitters is sometimes used for retrieving information from the subject. For example, certain eye-tracking systems utilize the information from two sources in order to be able to detect the eye movements of the subject. Advantageously, the two radiation transmitters may be arranged on opposite sides of the detector.

Said radiation transmitter may be designed to provide flashes in a non-visible spectrum, such as IR radiation. Advantageously, the radiation transmitter may be a LED transmitter.

In an advantageous embodiment, the instrument cluster may be provided with an interface for transmitting signals and/or for providing voltage, wherein said interface is connected both to the display and to the detector.

In another advantageous embodiment, said display forms a first unitary module, and said detector and reflector forms a second unitary module, for mounting in a dashboard panel of a vehicle. The first unitary module may be adapted such that it may be mounted in the dashboard without the second unitary module, if necessary with a “dummy” second module, not providing any functions. In this case, it will be possible to use the same first unitary module for creating instrument cluster arrangements with or without the subject monitoring features (with or without the true second module). This provides for streamlined manufacture of different vehicle models and for an opportunity to customize the instrument cluster arrangements to individual orders.

Advantageously, said first and second unitary modules may be connectable before mounting thereof in said dashboard panel, so as to enable mounting of the instrument cluster arrangement in the dashboard as one pre-assembled unit.

In a second aspect of the disclosure, there is provided a vehicle having a dashboard panel comprising an instrument cluster arrangement in accordance with the above.

In particular, there may be provided a vehicle having a dashboard panel comprising an instrument cluster arrangement where the detector is arranged at a location being at least potentially blocked from access to direct radiation from the subject by a steering wheel and/or a steering wheel hub of the vehicle.

In a third aspect of the disclosure, there is provided a method for mounting an instrument cluster arrangement in accordance with the above, comprising mounting said instrument cluster arrangement in the dashboard panel at a location such that radiation providing information regarding the subject in the vehicle may be directed from the subject to the reflector, and redirected by the reflector towards the detector.

Advantageously, the method may comprise mounting said instrument cluster arrangement in the dashboard panel at a location such that the detector is at least potentially blocked form access to direct radiation from the subject by a steering wheel and/or a steering wheel hub of the vehicle.

In a fourth aspect of the disclosure, there is provided the use of an instrument cluster arrangement in accordance with the above for providing information regarding the subject to a subject-monitoring application of the vehicle, in particular to an eye-tracking application.

Further variants of the disclosure will be understood by the following description of exemplary embodiments thereof, described in relation to the accompanying drawings, wherein:

### BRIEF DESCRIPTION OF THE DRAWINGS

FIG. 1 illustrates schematically a dashboard of a vehicle, wherein an instrument cluster arrangement is to be arranged;

FIG. 2 is a side view of an embodiment of an instrument cluster arrangement in accordance with the disclosure; and

FIG. 3 is a front view of the instrument cluster arrangement of FIG. 2.

Like reference numerals indicate similar features throughout the drawings.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

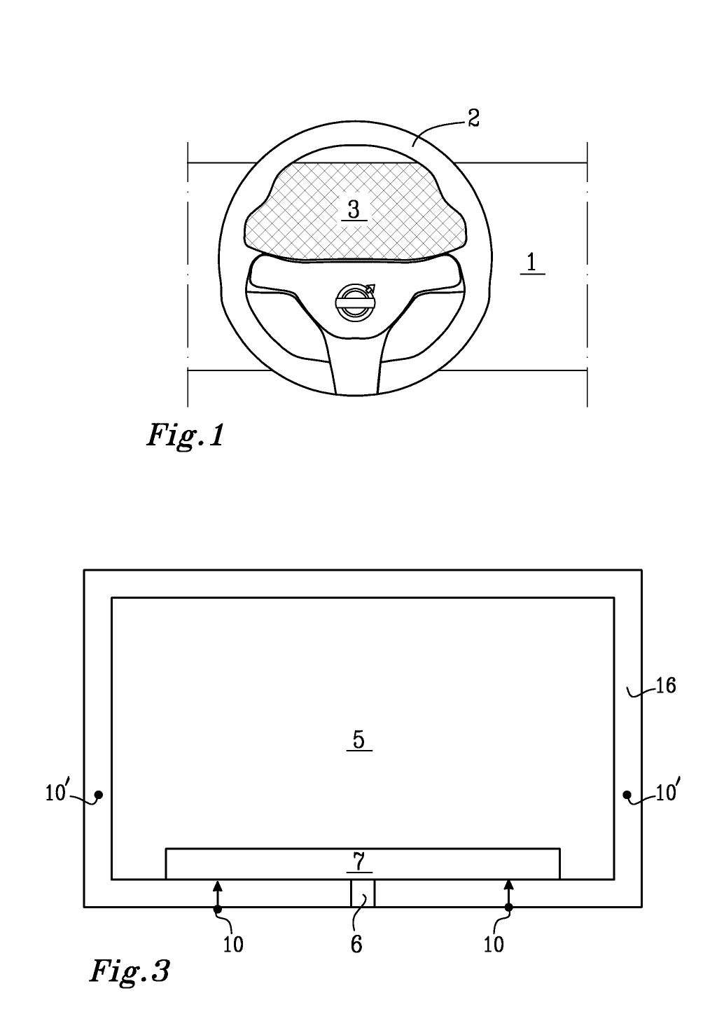

FIG. 1 illustrates schematically the portion of a dashboard panel 1 in a vehicle being in immediate proximity to the steering wheel 2. The portion 3 (striped) of the dashboard panel 1 being visible through the frame formed by the steering wheel (at least when the steering wheel is in a neutral position) is conventionally used for housing the instrument cluster, including the most important instruments to be available to the driver, such as the vehicle speed, engine speed, oil pressure etc.

In conventional instrument cluster arrangements, a number of separate instruments are arranged for presenting various data to the driver.

In more recent arrangements, it is desired to use a display, such as an LCD display, to present the same data to the driver. Naturally, it is desired to use as much as possible of the available visible portion 3 of the dashboard for said display, in order to maximize the display surface available for presenting information.

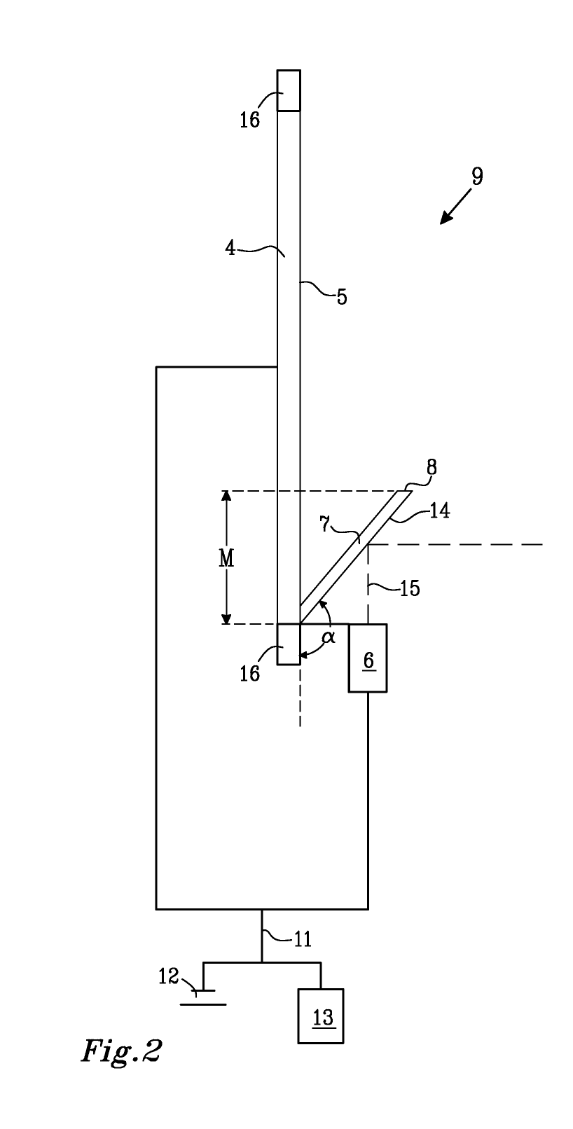

FIG. 2 illustrates schematically an embodiment of an instrument cluster arrangement 9 in accordance with the present disclosure. The instrument cluster comprises a display 4, having a display surface 5, intended to face the driver when the instrument cluster arrangement is mounted in the dashboard 1 of a vehicle. In the illustrated embodiment, the display is a LCD display. For visibility purposes, in FIG. 2 the size of the detector 6 and the reflector 7 are greatly exaggerated in comparison to the dimensions of the display 4.

A detector 6 for monitoring a subject, in particular the driver, inside the vehicle is arranged to receive radiation providing information regarding the driver, and a reflector 7 is arranged to redirect radiation from said subject towards said detector, as indicated by the dotted line illustrating the path which the radiation will follow between the subject and the detector 6.

In the illustrated embodiment, the detector 6 is located below the lowermost edge of the display surface 5, as seen from a subject. The display surface 5 is intended to extend over the entire vertical dimension of the visible portion 3 of the dashboard. This means that in this embodiment, the location of the detector 6 will be constantly blocked from access to direct radiation from the subject, due to the central region of the steering wheel coming in between the driver and said location.

Accordingly, a detector 6 being directed immediately towards the position of the driver would be unsuccessful in capturing the necessary radiation. Instead, the central region of the steering wheel (and/or the steering wheel hub) would block the radiation from reaching the detector 6.

Nevertheless, in the illustrated embodiment, radiation from the driver may be received by the detector, since the radiation is redirected at the reflector 7. It is understood, that at least a portion of the reflector 7 is positioned at a location which provides immediate access to radiation from the driver. However, since the reflector 7 may be rendered transparent to visible light, this does not hinder use of the entire display surface 5 of the display 4 for presenting information. Accordingly, the visible portion 3 of the dashboard may be efficiently used.

The reflector 7 may be a dichroic mirror, being transparent to visible light, but not to the radiation used for detection. Examples of such dichroic mirrors are well-known in the art.

In the illustrated embodiment, the detector 6 is arranged to receive radiation coming from a primary direction being essentially parallel to the display surface 5. The reflector 7 has a reflective surface 14, which forms an angle alfa in relation to the display surface. Angles alfa of at least 100 degrees, preferably between 115 and 155 degrees are believed to be particularly useful for providing a suitable radiation path. In the illustrated embodiment, the angle alfa is about 135 degrees.

The illustrated embodiment is believed to be particularly advantageous, but naturally, other variants are possible.

For example, the reflector 7 could be positioned at the upper edge of the display 4, and hence on the opposite side from the detector 6. However, in this case, the reflector 7 will require relatively large dimensions, since it must enable reflection of the radiation over the display surface 5 towards the detector 6.

Moreover, the angles between e.g. the display and the detector, and the reflector and the detector may be varied.

In the illustrated embodiment, it is seen how the reflector 7 extends from a basal end, at which it is fastened to the instrument cluster arrangement, and a free end. Said free end defines an end surface 8 which herein forms an angle of about 90 degrees with the display surface 5. Accordingly, the end surface 8 will become virtually invisible as seen from a direction of 90 degrees from the display surface.

Moreover, the reflector 7 extends over a margin surface of the display surface 5. This surface is most readily seen in FIG. 3. In FIG. 2, the vertical extension M of the margin surface is indicated.

As may be gleaned from FIG. 3, the illustrated embodiment of an instrument cluster arrangement moreover comprises radiation transmitters 10. In this embodiment, there are two radiation transmitters 10, arranged on horisontally opposing sides of the detector 6. In the illustrated embodiment, the radiation transmitters are LED transmitters.

In the illustrated embodiment, the radiation transmitters 10 are directed to emit radiation in a direction towards the reflector 7, as indicated by the arrows in FIG. 3. From the reflector 7, the radiation will be directed towards the driver so as to enable monitoring thereof. The radiation from both transmitters 10 will be reflected by the driver, back to the reflector 7 and towards the detector 6 which will detect the incoming radiation.

One or more radiation transmitters may be arranged at different locations in the instrument cluster. For example, radiation transmitters could be arranged e.g. at the sides of the display surface 4, as illustrated in FIG. 3 by alternative radiation transmitters 10′.

As schematically illustrated in FIG. 2, the display 4 and the detector 6, optionally also any radiation transmitters 10, could be connected to a common interface 11. Hence, one interface 11 could provide voltage 12 and/or data connection to a processor 13 for all components of the instrument cluster arrangement.

Regardless of how the connection is performed, the detector 6 should be connected to a processor 13 for evaluating the data from the detector 6 in order to monitor the driver. To this end, any known evaluation method may be used. Moreover, the processor 13 may send signals to control the detector 6 and/or the radiation transmitters in order to perform the monitoring of the driver. For example, the processor may control the radiation transmitters so as to be active at certain intervals to send flashes of radiation towards the driver etc.

In view of the above, it will be understood that numerous alternatives and different embodiments of the disclosure are possible. For example, the geometries of the reflector and the display surface may be adapted to various desires and circumstances.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An instrument cluster arrangement adapted for mounting in a dashboard panel of a vehicle, the arrangement comprising:
a display having a display surface providing a graphics area of the instrument cluster arrangement;
a detector for monitoring a subject inside the vehicle, said detector being configured to receive radiation providing information regarding the subject; and
a reflector configured to redirect radiation from said subject towards said detector; wherein the detector and the reflector are both configured to be arranged adjacent the display.

2. The instrument cluster arrangement in accordance with claim 1, the detector having an optical axis, and said detector configured to be arranged with said optical axis forming an angle with said display surface in the range −10 to 30 degrees.

3. The instrument cluster arrangement in accordance with claim 2, wherein said detector is configured to be arranged with said optical axis being essentially parallel to said display surface.

4. The instrument cluster arrangement in accordance with claim 1, wherein said reflector is configured to be arranged between the detector and the display surface.

5. The instrument cluster arrangement in accordance with claim 1, wherein said display is configured to extend between an upper edge and a lower edge, and said reflector and said detector are configured to be arranged adjacent to the lower edge of the display.

6. The instrument cluster arrangement in accordance with claim 1, wherein said reflector is configured to be arranged so as to extend over a margin area of the display surface, said margin area constituting less than 10% of the total area of the display surface.

7. The instrument cluster arrangement in accordance with claim 1, wherein the reflector is configured to extend from a basal end configured to be arranged adjacent to said display area, and a free end opposite said basal end, said free end having an end surface forming an angle of approximately 90 degrees in relation to the display surface.

8. The instrument cluster arrangement in accordance with claim 1, wherein said reflector is transparent to visible light and reflective to said radiation, said reflector being a dichroic reflector.

9. The instrument cluster arrangement in accordance with claim 1, further comprising at least one radiation transmitter configured to be arranged adjacent said display, for transmitting radiation towards the subject.

10. The instrument cluster arrangement in accordance with claim 9, wherein said at least one radiation transmitter is configured to be arranged to transmit radiation in a direction towards the reflector, such that the reflector redirects the radiation towards the subject.

11. The instrument cluster arrangement in accordance with claim 1, wherein said instrument cluster is provided with an interface for transmitting signals and/or for providing voltage, wherein said interface is configured to be connected both to the display and to the detector.

12. The instrument cluster arrangement in accordance with claim 1, wherein said display forms a first unitary module, and said detector and reflector form a second unitary module, for mounting in a dashboard panel of a vehicle, said first and second unitary modules being connectable before mounting in said dashboard panel, so as to enable mounting of the instrument cluster arrangement in the dashboard as one assembled unit.

13. A vehicle comprising an instrument cluster arrangement mounted in a dashboard panel, the arrangement comprising:
a display having a display surface providing a graphics area of the instrument cluster arrangement;
a detector for monitoring a subject inside the vehicle, said detector arranged to receive radiation providing information regarding the subject; and
a reflector arranged to redirect radiation from said subject towards said detector;
wherein the detector and the reflector are both arranged adjacent the display.

14. A method for using an instrument cluster arrangement for a dashboard panel of a vehicle, the arrangement including a display having a display surface providing a graphics area of the instrument cluster arrangement, a detector for monitoring a subject inside the vehicle, said detector configured to be arranged to receive radiation providing information regarding the subject, and a reflector configured to be arranged to redirect radiation from said subject towards said detector, wherein the detector and the reflector are both configured to be arranged in said instrument cluster arrangement adjacent the display, the method comprising:
mounting said instrument cluster arrangement in the dashboard panel at a location such that radiation providing information regarding the subject in the vehicle may be directed from the subject to the reflector, and redirected by the reflector towards the detector.

15. The method of claim 14 further comprising configuring the instrument cluster arrangement for providing information regarding the subject to a subject-monitoring application, such as an eye-detection and/or head tracking application.

16. The instrument cluster arrangement in accordance with claim 1, the detector having an optical axis, and said detector configured to be arranged with said optical axis forming an angle with said display surface in the range −10 to 15 degrees.

17. The instrument cluster arrangement in accordance with claim 1, the detector having an optical axis, and said detector configured to be arranged with said optical axis forming an angle with said display surface in the range −10 to 10 degrees.

18. The instrument cluster arrangement in accordance with claim 1, wherein said reflector is configured to be arranged so as to extend over a margin area of the display surface, said margin area constituting less than 5% of the display surface.

19. The instrument cluster arrangement in accordance with claim 1, wherein said reflector is transparent to visible light and reflective to said radiation.

20. The instrument cluster arrangement in accordance with claim 1, further comprising two radiation transmitters configured to be arranged adjacent said display, for transmitting radiation towards the subject, the radiation transmitters configured to be arranged on opposite sides of the detector.
